(19) United States
(12) Patent Application Publication
(10) Pub. No.: US 2024/0100892 A1
(43) Pub. Date: Mar. 28, 2024

(54) SINGLE ANTENNA TIRE PRESSURE DETECTION SYSTEM AND METHOD FOR OPERATING THE SAME

(71) Applicant: SHIH-CHIN CHO, TAIPEI CITY (TW)

(72) Inventor: SHIH-CHIN CHO, TAIPEI CITY (TW)

(21) Appl. No.: 18/519,064

(22) Filed: Nov. 26, 2023

Related U.S. Application Data
(63) Continuation-in-part of application No. 17/361,335, filed on Jun. 29, 2021.

(51) Int. Cl. B60C 23/04

(52) U.S. Cl. CPC B60C 23/0452; B60C 23/0438; B60C 23/0479

(57) ABSTRACT

A single antenna tire pressure detection system and a method for operating the same includes a detection end and a receiving end. The detection end detects the tire pressure through tire pressure detectors to obtain tire condition information. The tire pressure detectors provides two types of signal output modes which are radio frequency (RF) signals and short-distance RF signals. These signals are transmitted not only to the original in-vehicle tire pressure receiving device but also displayed on the in-car entertainment system and the user's mobile device, showing tire condition information.

The present invention is a Continuation-In-Part patent application of applicant's former patent application with the application Ser. No. 17/361,335.

### BACKGROUND OF THE INVENTION

### 1. Fields of the Invention

### 2. Descriptions of Related Art

The present invention relates to a tire pressure detection system, and more particularly, to a tire pressure detection system that sends information of the tire pressure to a remote receiving device.

### 2. Descriptions of Related Art

The conventional tire pressure detector only has a single wireless signal transmission mode in the form of radio frequency (RF) signal or short-distance RF circuit signals. The signals of the detected tire are sent to a receiving device on the vehicle so that the users is acknowledged about the pressure and temperature information of the tire.

When the users want to use car audio-visual devices or mobile devices (car entertainment systems and mobile devices hereinafter referred to as external devices) as a reading/displaying device for displaying the tire information. However, because the detected signals are different, so that a signal receiving converter is required to be installed in the car. The signal receiving converter not only occupies a certain space in the car, but also requires additional power supply which usually occupies the cigarette lighter power supply socket or power socket, which has its problems to be overcome.

The present invention intends to provide a tire pressure detection system with single antenna to eliminate shortcomings mentioned above.

### SUMMARY OF THE INVENTION

The present invention relates to a single antenna tire pressure detection system, and comprises a detection end and a receiving end. The detection end includes multiple tire pressure detectors, and the receiving end includes a tire-pressure receiving device, an entertainment system and a mobile device. Each of the tire pressure detectors includes a tire status detection unit, a single control unit, a switch unit, an antenna unit, a radio frequency circuit and a short-distance RF circuit.

The single control unit is electrically connected to the tire status detection unit, the radio frequency circuit and the short-distance RF circuit. The switch unit is electrically connected to the single control unit and the antenna unit. The tire status detection unit is operated under a vehicle monitoring mode and detects the tire status. The single control unit transfers the information of the tire status into a control transferring signal, and the single control unit sends the control transferring signal out.

The radio frequency circuit includes a radio frequency control unit and a radio frequency matching unit. The radio frequency matching unit is electrically connected with the radio frequency control unit and the switch unit. The radio frequency control unit receives the control transferring signal and transfers the control transferring signal into a radio frequency single. The radio frequency matching unit adjusts the control transferring signal into a pre-set radio frequency impedance matching.

The short-distance RF circuit includes a short-distance RF circuit control unit and a short-distance RF circuit matching unit. The short-distance RF circuit matching unit is electrically connected to the short-distance RF circuit control unit and the switch unit. The short-distance RF circuit control unit receives the control transferring signal and transfers the control transferring signal into a short-distance RF circuit signal. The short-distance RF circuit matching unit transfers the control transferring signal into a pre-set short-distance RF circuit impedance matching.

The single control unit demands the switching unit to switch the antenna unit based on the radio frequency signals or the short-distance radio frequency circuit signals into corresponding frequency band. The frequency signal and the short-distance RF circuit signal individually or simultaneously are output to any one or more than two of the tire-pressure receiving device, the entertainment system and the mobile device to display the tire status;

When the receiving end completes receiving the tire status from the detection end, the receiving end sends a short-distance radio frequency control signal to the detection end to switch the tire pressure detector from the vehicle monitoring mode to a sleep mode until the tire pressure detector receives a wake-up request from the receiving end in the form of a short-distance radio frequency control signal, and

When the receiving end is unable to receive the tire status information from the detection end, the receiving end sends a short-distance radio frequency control signal to the detection end, prompting the tire pressure detector to restart the vehicle monitoring mode.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the block diagram of the single antenna tire pressure detection system of the present invention;

FIG. 2 illustrates the block diagram of the tire pressure detector, the tire-pressure receiving device, the entertainment system and the mobile device;

FIG. 3 illustrates that the tire pressure detector, the tire-pressure receiving device, the entertainment system and the mobile device are communicated with each other via wirelessly transferring signals;

FIG. 4 illustrates a block diagram of the tire pressure detector of the present invention;

FIG. 5 shows that the tire-pressure receiving device and the entertainment system receive the tire status from the tire pressure detector, and

FIG. 6 shows the steps of the method for operation the single antenna tire pressure detection system of the present invention.

### DETAILED DESCRIPTION OF THE PREFERRED EMBODIMENT

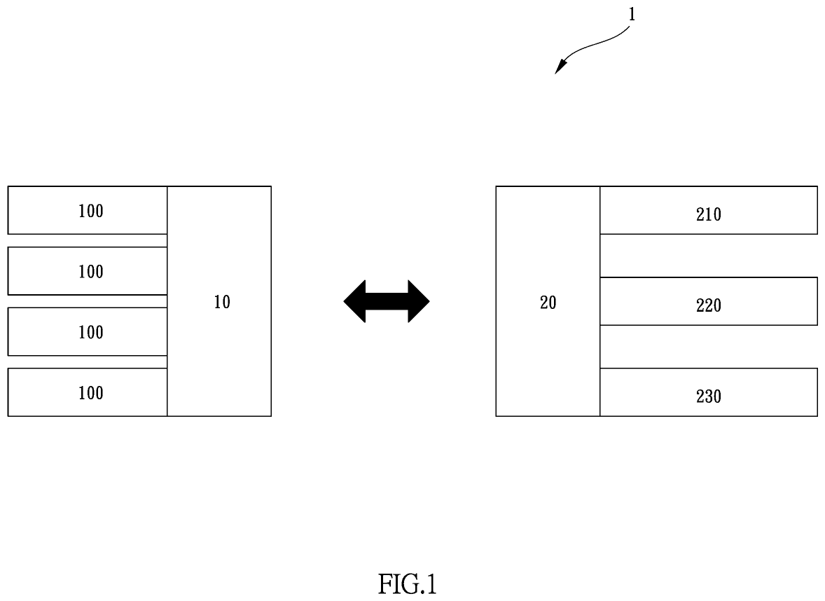

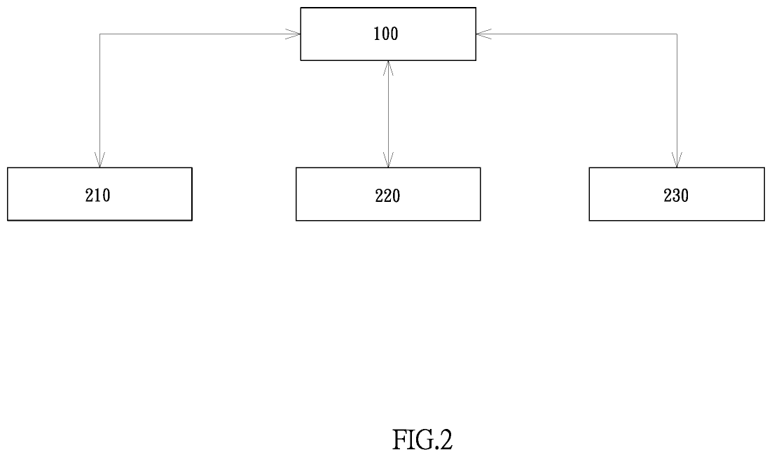

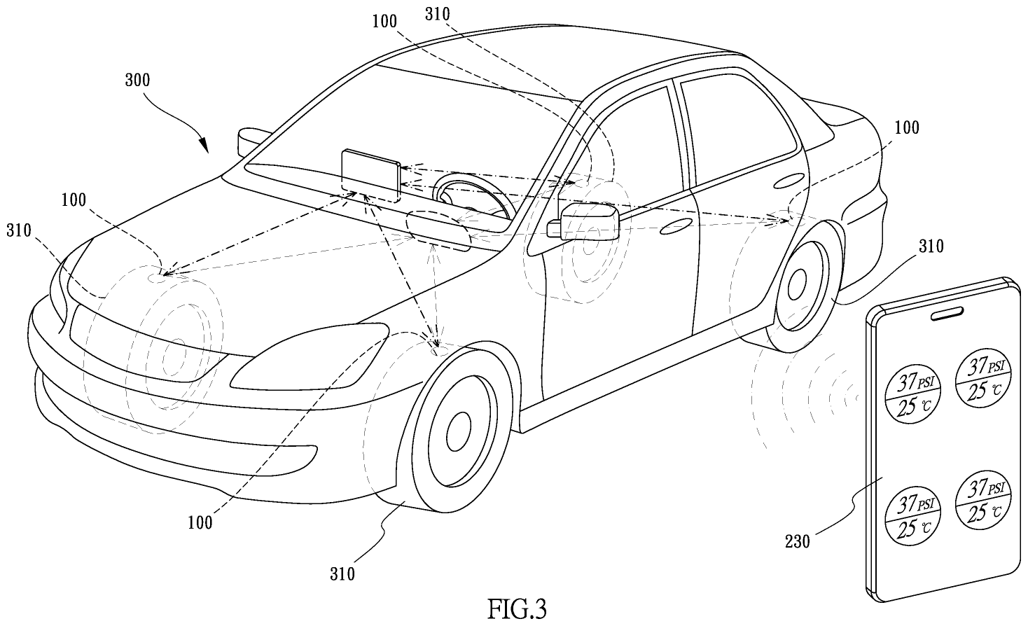

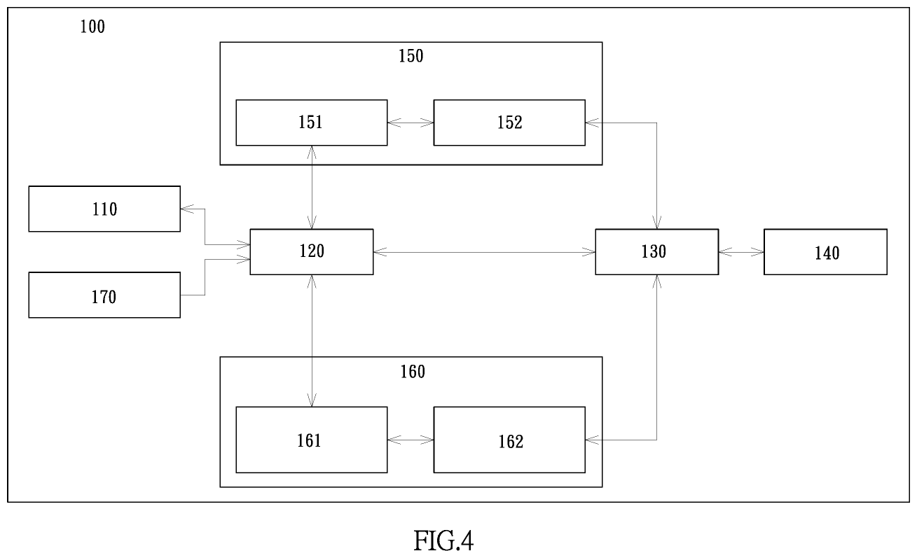

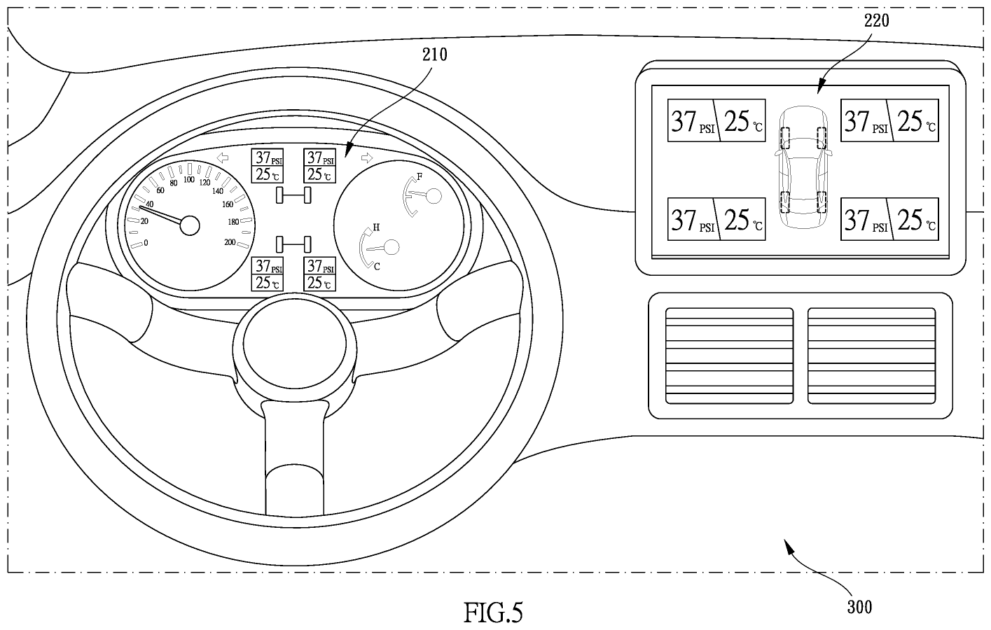

Referring to FIGS. 1 to 5, the single antenna tire pressure detection system 1 of the present invention comprises a detection end 10 and a receiving end 20. The detection end 10 including multiple tire pressure detectors 100. In this embodiment, there are four tire pressure detectors 100 respectively installed to four tires 310 of a vehicle 300. The receiving end 20 includes a tire-pressure receiving device 210, an entertainment system 220 and a mobile device 230. The tire-pressure receiving device 210 is built in the vehicle 30 by the manufacturers. The entertainment system 220 can be a built-in equipment or an externally installed device. The mobile device 230 can be the users' small phones.

Each of the tire pressure detectors 100 includes a tire status detection unit 110, a single control unit 120, a switch unit 130, an antenna unit 140, a radio frequency circuit 150 and a short-distance RF circuit 160 (Bluetooth circuit).

The single control unit 120 is electrically connected to the tire status detection unit 110, the radio frequency circuit 150 and the short-distance RF circuit 160. The switch unit 130 is electrically connected to the single control unit 120 and the antenna unit 140. The tire status detection unit 110 is operated under a vehicle monitoring mode and continuously detects the tire status, and the single control unit 120 transfers the information of the tire status into a control transferring signal. The single control unit 120 sends the control transferring signal out.

The radio frequency circuit 150 includes a radio frequency control unit 151 and a radio frequency matching unit 152. The radio frequency matching unit 152 is electrically connected with the radio frequency control unit 151 and the switch unit 130. The radio frequency control unit 151 receives the control transferring signal and transfers the control transferring signal into a radio frequency single. The radio frequency matching unit 152 adjusts the control transferring signal into a pre-set radio frequency impedance matching.

The short-distance RF circuit 160 includes a short-distance RF circuit control unit 161 (Bluetooth control unit), a short-distance RF circuit matching unit 162 (Bluetooth matching unit). The short-distance RF circuit matching unit 162 is electrically connected to the short-distance RF circuit control unit 161 and the switch unit 130. The short-distance RF circuit control unit 161 receives the control transferring signal and transfers the control transferring signal into a short-distance RF circuit signal. The short-distance RF circuit matching unit 162 transfers the control transferring signal into a pre-set short-distance RF circuit impedance matching.

The single control unit 120 demands the switch unit 130 to switch the antenna unit 140 into a corresponding frequency band according to the frequency signal or the short-distance RF circuit signal. The frequency signal and the short-distance RF circuit signal individually or simultaneously are output to any one or more than two of the tire-pressure receiving device 210, the entertainment system 220 and the mobile device 230 to display the tire status.

When in use, the detection end 10 of the single antenna tire pressure detection system 1 detects the tire status of the tire 310, such as the tire pressure and the tire interior temperature, by the tire status detection unit 110 of the tire pressure detector 100. The single control unit 120 sends the detected information to the receiving end 20 in the form of radio frequency signal and short-distance RF circuit signal by radio frequency circuit 150 and the short-distance RF circuit 160. The single control unit 120 demands the switch unit 130 to switch the antenna unit 140 into a corresponding frequency band according to the frequency signal or the short-distance RF circuit signal. The frequency signal and the short-distance RF circuit signal are individually or simultaneously output to any one or more than two of the tire-pressure receiving device 210, the entertainment system 220 and the mobile device 230 to display the tire status.

The tire pressure detector 100 provides two types of signals which are the radio frequency signal and the short-distance RF circuit signal, to not only the tire-pressure in-car receiving device 210, also the tire status cab display on the entertainment system 220 and the mobile device 230 without extra signal converters so as to improve the problems of the conventional tire pressure detector system.

It is noted that when the receiving end 220 completes receiving the tire status from the detection end 10, the receiving end 20 (one of the in-car receiving device 210, the in-car entertainment system 220 and the mobile device 230) sends a short-distance radio frequency control signal to the detection end 10 to switch the tire pressure detector 100 from the vehicle monitoring mode to a sleep mode until the tire pressure detector 100 receives a wake-up request from the receiving end 20 (one of the in-car receiving device 210, the in-car entertainment system 220 and the mobile device 230) in the form of a short-distance radio frequency control signal. When the receiving end 20 is unable to receive the tire status information from the detection end 10, the receiving end 20 sends a short-distance radio frequency control signal to the detection end 10, prompting the tire pressure detector 100 to restart the vehicle monitoring mode.

It is noted that the radio frequency signal is a 315 MHz and 433.92 MHz transferring signal, and the short-distance RF circuit signal is a 2.4 GHz transferring signal.

The single control unit 120 sends the control transferring signal to the radio frequency control unit 151 and the short-distance RF circuit control unit 161 by any one or more than two of a pre-set sequence, a pre-set number of times and a pre-set of time.

Each of the tire pressure detectors 100 includes a calling unit 170 which is electrically connected to the single control unit 120.

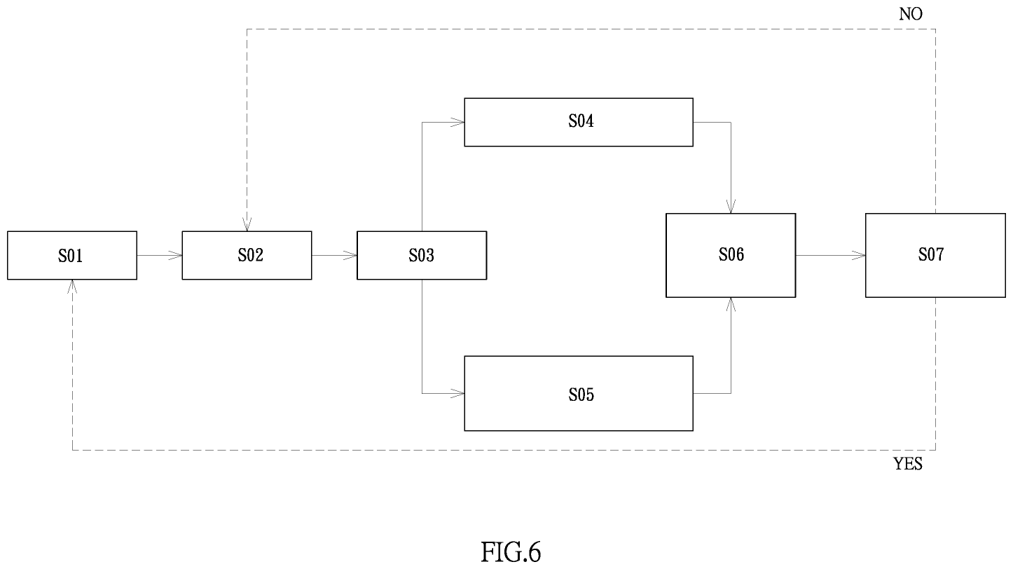

FIG. 6 shows the method for operating a single antenna tire pressure detection system and comprises the following steps:
a wake-up step S01: the tire pressure detector 100 at the detection end 10 being awakened by a wake-up unit 170 through vibration or centrifugal action, transitioning the tire pressure detector 100 from a sleep mode to a vehicle monitoring mode, wherein the wake-up behavior refers to the scenario where the vehicle, when originally parked for an extended period and turned off, is subsequently started and driven by the driver. It does not refer to the situation where the vehicle briefly stops at a traffic light waiting for a green signal and then resumes driving;
a detection step S02: after awakening, the single control unit 120 demanding the tire pressure detector 100 to monitor pressure and internal temperature of a tire 310 to obtain information of tire status, the information of tire status being converted into control transmission signals and outputted;
a configuration step S03: the single control unit 120 configuring a combination of sequence, frequency, and time intervals for transmitting the transmission signals to a radio frequency control unit 151 and a short-distance radio frequency circuit control unit 161;
a radio frequency signal matching step S04: when outputting as radio frequency signals, the radio frequency control unit 151 receiving the control transmission signals and converting the control transmission signals into radio frequency signals, the radio frequency matching unit 152 adjusting the control transmission signals to be radio frequency impedance matching;
a short-distance radio frequency circuit signal matching step S05: when outputting as short-distance radio frequency circuit signals, the short-distance radio frequency circuit control 161 unit receiving the control transmission signals and converting the control transmission signals into short-distance radio frequency circuit signals, the short-distance radio frequency circuit matching unit 162 adjusting the control transmission signals into short-distance radio frequency circuit impedance;
a frequency band switching and outputting step S06: the single control unit 120 demanding the switching unit 130 to switch an antenna unit 140 to corresponding frequency band based on the radio frequency signal or the short-distance radio frequency circuit signal, the radio frequency signals or the short-distance radio frequency circuit signals being outputted to one or more than one of a tire pressure receiving device 210, an in-car entertainment system 220 or a mobile device 230 individually or in combination, displaying the tire condition information, and
a controlling the detection end by the receiving end step S07: when the receiving end 20 (the in-car receiving device 210, the in-car entertainment system 220 and the mobile device 230) completes receiving and displaying the information of tire status from the detection end 10, the receiving end 20 sending a short-distance radio frequency control signal to the tire pressure detector 100 at the detection end 10 to activate the tire pressure detector 100 to switch from a vehicle monitoring mode to a sleep mode and awaiting a wake-up request from the receiving end 20, returning to the wake-up step S01 (as shown by the “YES” path in FIG. 6, the step 07), when the receiving end 20 is unable to receive the information of tire status from the detection end 10, the receiving end 20 sends a short-distance radio frequency control signal to the tire pressure detector 100 at the detection end 10 to cause the tire pressure detector 100 to return to the detection step S02 (as shown by the “NO” path in FIG. 6, the step 07), and restart the vehicle monitoring mode.

While we have shown and described the embodiment in accordance with the present invention, it should be clear to those skilled in the art that further embodiments may be made without departing from the scope of the present invention.

What is claimed is:

1. A tire pressure detection system with single antenna comprising:
a detection end and a receiving end, the detection end including multiple tire pressure detectors, the receiving end including a tire-pressure receiving device, an entertainment system and a mobile device;
each of the tire pressure detectors including a tire status detection unit, a single control unit, a switch unit, an antenna unit, a radio frequency circuit and a short-distance RF circuit;
the single control unit electrically connected to the tire status detection unit, the radio frequency circuit and the short-distance RF circuit, the switch unit electrically connected to the single control unit and the antenna unit, the tire status detection unit being operated in a vehicle monitoring mode and detecting a tire status, the single control unit transferring an information of the tire status into a control transferring signal, the single control unit sending the control transferring signal out;
the radio frequency circuit including a radio frequency control unit and a radio frequency matching unit, the radio frequency matching unit electrically connected with the radio frequency control unit and the switch unit, the radio frequency control unit receiving the control transferring signal and transferring the control transferring signal into a radio frequency single, the radio frequency matching unit adjusting the control transferring signal into a pre-set radio frequency impedance matching;
the short-distance RF circuit including a short-distance RF circuit control unit and a short-distance RF circuit matching unit, the short-distance RF circuit matching unit electrically connected to the short-distance RF circuit control unit and the switch unit, the short-distance RF circuit control unit receiving the control transferring signal and transferring the control transferring signal into short-distance RF circuit signal, the short-distance RF circuit matching unit transferring the control transferring signal into a pre-set short-distance RF circuit impedance matching;
the single control unit demanding the switching unit to switch the antenna unit based on the radio frequency signals or the short-distance radio frequency circuit signals into corresponding frequency band, the frequency signal and the short-distance RF circuit signal individually or simultaneously being output to any one or more than two of the tire-pressure receiving device, the entertainment system and the mobile device to display the tire status;
when the receiving end completes receiving the tire status from the detection end, the receiving end sends a short-distance radio frequency control signal to the detection end to switch the tire pressure detector from the vehicle monitoring mode to a sleep mode until the tire pressure detector receives a wake-up request from the receiving end in the form of a short-distance radio frequency control signal, and
when the receiving end is unable to receive the tire status information from the detection end, the receiving end sends a short-distance radio frequency control signal to the detection end, prompting the tire pressure detector to restart the vehicle monitoring mode.

2. The tire pressure detection system with single antenna as claimed in claim 1, wherein the radio frequency signal is a 315 MHz and 433.92 MHz transferring signal, the short-distance RF circuit signal is a 2.4 GHz transferring signal, the tire status includes tire pressure and tire temperature.

3. The tire pressure detection system with single antenna as claimed in claim 1, wherein each of the tire pressure detectors includes a calling unit which is electrically connected to the single control unit.

4. The tire pressure detection system with single antenna as claimed in claim 1, wherein the single control unit sends the control transferring signal to the radio frequency control unit and the short-distance RF circuit control unit by a pre-set sequence.

5. The tire pressure detection system with single antenna as claimed in claim 1, wherein the single control unit sends the control transferring signal to the radio frequency control unit and the short-distance RF circuit control unit by a pre-set number of times.

6. The tire pressure detection system with single antenna as claimed in claim 1, wherein the single control unit sends the control transferring signal to the radio frequency control unit and the short-distance RF circuit control unit by a pre-set of time.

7. The tire pressure detection system with single antenna as claimed in claim 1, wherein the single control unit sends the control transferring signal to the radio frequency control unit and the short-distance RF circuit control unit by one of or two of a pre-set sequence, a pre-set number of times and a pre-set of time.

8. A method for operating a single antenna tire pressure detection system and comprising:
a wake-up step: the tire pressure detector at the detection end being awakened by a wake-up unit through vibration or centrifugal action, transitioning the tire pressure detector from a sleep mode to a vehicle monitoring mode;
a detection step: after awakening, the single control unit demanding the tire pressure detector to monitor tire pressure and internal tire temperature to obtain information of tire status, the information of tire status being converted into control transmission signals and outputted;
a configuration step: the single control unit configuring a combination of sequence, frequency, and time intervals for transmitting the transmission signals to a radio frequency control unit and a short-distance radio frequency circuit control unit;
a radio frequency signal matching step: when outputting as radio frequency signals, the radio frequency control unit receiving the control transmission signals and converting the control transmission signals into radio frequency signals, the radio frequency matching unit adjusting the control transmission signals to be radio frequency impedance matching;
a short-distance radio frequency circuit signal matching step: when outputting as short-distance radio frequency circuit signals, the short-distance radio frequency circuit control unit receiving the control transmission signals and converting the control transmission signals into short-distance radio frequency circuit signals, the short-distance radio frequency circuit matching unit adjusting the control transmission signals into short-distance radio frequency circuit impedance;
a frequency band switching and outputting step: the single control unit demanding the switching unit to switch an antenna to corresponding frequency band based on the radio frequency signal or the short-distance radio frequency circuit signal, the radio frequency signals or the short-distance radio frequency circuit signals being outputted to one or more than one of a tire pressure receiving device, in-car entertainment system, or mobile devices, either individually or in combination, displaying the tire condition information, and
a controlling the detection end by the receiving end step: when the receiving end completes receiving and displaying the information of tire status from the detection end, the receiving end sending a short-distance radio frequency control signal to the tire pressure detector at the detection end to activate the tire pressure detector to switch from a vehicle monitoring mode to a sleep mode and awaiting a wake-up request from the receiving end, returning to the wake-up step, when the receiving end is unable to receive the information of tire status from the detection end, the receiving end sends a short-distance radio frequency control signal to the tire pressure detector at the detection end to cause the tire pressure detector to return to the detection step and restart the vehicle monitoring mode.
